(19) United States
(12) Patent Application Publication
(10) Pub. No.: US 2007/0278024 A1
(43) Pub. Date: Dec. 6, 2007

(54) TRANSPORTATION DEVICE AND POWER SYSTEM THEREOF

(76) Inventor: A-Song Liu, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/693,714

(22) Filed: Mar. 30, 2007

(30) Foreign Application Priority Data
Jun. 5, 2006 (TW) 95209709

(51) Int. Cl. B60K 15/00

(52) U.S. Cl. 180/69.5

(57) ABSTRACT

A power system suitable for use in a transportation device is provided. The power system includes an engine, a gas tank and a gas pipe. The engine has at least a gas cylinder with a piston. The gas tank is used for storing a high pressure noninflammable gas. The gas pipe is connected to the engine and the gas tank. The high pressure noninflammable gas is delivered into the cylinder via the gas pipe to drive the piston so as to drive and move the transportation device. Therefore the transportation device of the present invention can replace the transportation device which uses fuel as the power source.

### CROSS-REFERENCE TO RELATED APPLICATION

This application claims the priority benefit of Taiwan application serial no. 95209709, filed Jun. 5, 2006. All disclosure of the Taiwan application is incorporated herein by reference.

### BACKGROUND OF THE INVENTION

1. Field of the Invention

The present invention generally relates to a power system of a transportation device, and more particularly, relates to a power system for a vehicle.

2. Description of Related Art

Oil is the most demanded energy in the world. However, the world oil resources are not inexhaustible, sooner or later, oil will be exhausted. Even though today's technology is highly developed, the current means of transportation, such as automobiles and motorcycles, still use gasoline derived from oil as the power source.

However, the world oil resources are being consumed, while the total volume of oil in the world is a fixed number. There will be one day when all the oil in the world will be exhausted if the oil is being consumed constantly. The world will face a critical crisis of energy shortage, and all means of transportation using gasoline as the power source will no longer be able to operate due to gas shortage.

In addition, since the volume of oil in the world is decreasing gradually, as a result, today's oil price increases constantly. People have to pay more to keep the transportation means running; therefore the cost of the power source of transportation is increased.

Accordingly, the present invention provides a power system and a transportation device thereof which doesn't require any fuels so as to replace the current automobiles. Thus the problems occurring when all the oil in the world is exhausted, and the problems caused by the increasing oil price can be resolved.

### SUMMARY OF THE INVENTION

The present invention is directed to provide a transportation device and a power system thereof which can replace the current automobiles using gasoline as the power source, so that the power system and the transportation device of the present invention can be used as future means of transportation when the oil in the world is exhausted.

The present invention is also directed to provide a transportation device and a power system thereof to replace the automobiles using fuels such as gasoline and natural gas as the power source. Since the transportation device of the present invention does not consume fuels to operate, therefore the costs on the power source of current means of transportation can be reduced.

The present invention provides a transportation device which includes a vehicle body and a power system. The vehicle body has at least two wheels to move the transportation device. The power system has an engine, a gas tank and a gas pipe. The engine has at least a cylinder comprising a piston. The piston is operated to drive the wheels to move the vehicle body. A high pressure gas used to push the piston is stored in the gas tank, which is noninflammable. The gas pipe is connected to the engine and the gas tank, and the gas pipe delivers the high pressure gas in the gas tank to the engine, so that the high pressure gas can push the piston.

The present invention also provides a transportation device including a vehicle body and a power system. The vehicle body has at least two wheels to move the vehicle body. The power system includes an engine, a gas tank and a gas pipe. The engine has at least a cylinder comprising a piston. The piston is operated to drive the wheels to move the vehicle body. The gas tank stores high pressure noninflammable gas used to push the piston. The gas pipe is connected to the engine and the gas tank. The gas pipe delivers the high pressure gas stored in the gas tank to the engine to push the piston.

In order to achieve above or other objects, the present invention provides a power system for a transportation device. The power system includes an engine, a gas tank and a pipe. The engine has at least a cylinder comprising a piston. The piston is operated to drive the wheels to move the vehicle body so that the transportation device moves. A high pressure gas used to push the piston is stored in the gas tank, which is noninflammable. The gas pipe connects the engine and the gas tank to transport the high pressure gas stored in gas tank to the engine, so that the high pressure gas can push the piston.

In an embodiment of the present invention, the gas pipe of the power system has a switch valve. When the switch valve is turned on, the high pressure gas in the gas tank enters the cylinder of engine via gas pipe to drive and move the vehicle body. When the switch valve is turned off, the switch valve restricts the high pressure gas from entering the cylinder so that the transportation device stops moving.

In an embodiment of the present invention, the gas tank has a check valve. The high pressure gas enters the gas tank through the check valve, so that the high pressure gas is stored in the gas tank. The outer end of the above check valve can be connected to an air compressor or a steel gas cylinder which provides the high pressure gas.

According to the above description, the working principle of the present invention is that the pressure of the high pressure gas is employed to push the piston in the cylinder to drive the wheels to move the transportation device. Thus, the transportation device of the present invention can replace the automobiles that use gasoline as the power source. And therefore the fuel shortage problem when all the oil in the world is exhausted can be resolved. In addition, the fuel cost of transportation can also be reduced without worrying about the daily increased oil price.

These and other exemplary embodiments, features, aspects, and advantages of the present invention will be described and become more apparent from the detailed description of exemplary embodiments when read in conjunction with accompanying drawings.

### BRIEF DESCRIPTION OF THE DRAWINGS

FIG. 1 is a schematic diagram of a transportation device of the present invention.

FIG. 2 is a schematic diagram of another transportation device of the present invention.

FIG. 3 is an external view of a cylinder of an engine of the present invention.

FIG. 4A-4C is a diagram of showing an operation of a cylinder according to an embodiment of the present invention.

FIG. 5 is an external view of a cylinder of another engine according to another embodiment of the present invention.

### DETAIL DESCRIPTION OF THE PREFERRED EMBODIMENTS

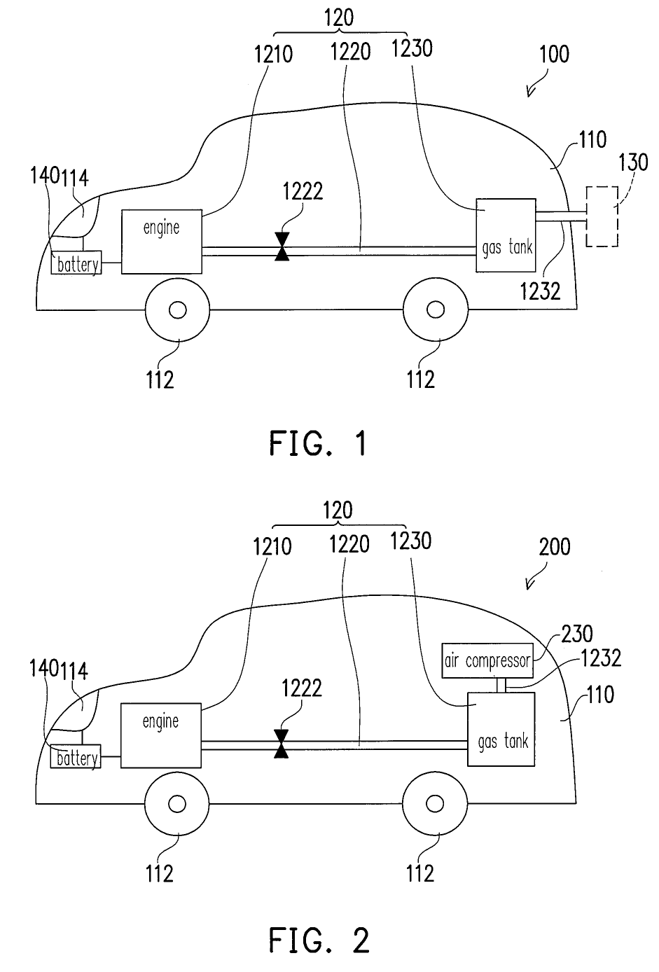

FIG. 1 is a schematic diagram of a transportation device of the present invention. As shown in FIG. 1, the transportation device 100 comprises a vehicle body 110 and a power system 120. The vehicle body 110 has at least two wheels 112 configured to move the vehicle body 110. In FIG. 1, the transportation device 100 is illustrated as a transportation device with four wheels. However the transportation device of the present invention can also be a two-wheeler motorcycle, three-wheeler transportation device or a transportation device with five or more wheels. The transportation device of the present invention can also comprise a pedrail configured to move the vehicle body.

In addition, the transportation device 100 further comprises a battery 140. Besides providing power to the lamps 114, the battery 140 can also provide power to the electronic equipments disposed on the vehicle body 110, such as radio, recorder or CD player, etc. Battery 140 can be a lead-acid battery.

The power system 120 has an engine 1210, a gas pipe 1220 and a gas tank 1230. The engine 1210 is used to drive and to move the vehicle body 110. The gas tank 1230 stores high pressure noninflammable gas. The gas pipe 1220 is connected to the engine 1210 and the gas tank 1230 delivers the high pressure noninflammable gas to the engine 1210, so that the engine 1210 can drive the vehicle body 110 without using fuel.

The gas pipe 1220 has a switch valve 1222 to control the delivery of the high pressure gas to the engine 1210. The switch valve 1222 can be a regular gas pipe valve, such as a magnetic valve or a gas valve. When the switch valve 1222 is turned on, the high pressure gas enters the engine 1210. Due to the high pressure of the high pressure gas, the engine 1210 drives and moves the vehicle body 110. When the switch valve 1222 is turned off, the gas pipe 1220 is blocked to prevent the high pressure gas from entering into the engine 1210 so that no high pressure gas is delivered to the engine 1210, and therefore the engine 1210 can not drive vehicle body 110, and thus vehicle body 110 stops moving.

The reason why the high pressure gas in the gas tank 1230 can be delivered to the engine 1210 is that the pressure in the gas tank 1230 is higher than the pressure in the gas pipe 1220 and the engine 1210. Thus the high pressure gas can be transported from the gas tank 1230 to the engine 1210 via the gas pipe 1220. Therefore in order to transport the high pressure gas from the gas tank 1230 to the engine 1210, the pressure in the gas tank 1230 should be maintained at a higher pressure relative to that in the engine 1210. As the high pressure gas in gas tank 1230 is depleted, the pressure of the high pressure gas in the gas tank 1230 is correspondingly reduced, and when the pressure in the gas tank 1230 is reduced a pressure equivalent to that in the gas pipe 1220, the transportation of the high pressure gas from the gas tank 1230 to the engine 1210 stops. At this time, high pressure gas needs to be filled into the gas tank 1230 from an external source.

The high pressure gas may be filled into the gas tank 1230 from an external source via a check valve 1232 on the gas tank 1230. To fill the high pressure gas from the external source, as shown in FIG. 1, first, the check valve 1232 is connected to a steel gas cylinder 130 to fill the high pressure gas from the steel gas cylinder 130 to the gas tank 1230. Thus, the pressure in the gas tank 1230 becomes higher than that of the gas pipe 1220 and the engine 1210 so that the high pressure gas from gas tank 1230 can be delivered to the engine 1210.

The high pressure gas may also be filled into the gas tank 1230 from the external source using other methods. Referring to FIG. 2, the components of the transportation device 200 is similar to that of the transportation device 100 except that the transportation device 200 comprises an air compressor 230 instead of the steel gas cylinder 130. The air compressor 230, which is disposed inside the vehicle body 110, generates the high pressure gas and fills the high pressure gas into the gas tank 1230. Thus, the pressure in the gas tank 1230 is higher than that in the gas pipe 1220 and the engine 1210.

It should be noted that other external sources such as car dealers or auto repair shops may also supply the high pressure gas, which can be used to fill the gas tank 1230.

In addition, the gas tank 1230 also comprises a pressure gage (not shown in the diagram) to measure the pressure of the high pressure gas inside the gas tank 1230 which may serve to indicate the content of the high pressure gas inside the gas tank 1230.

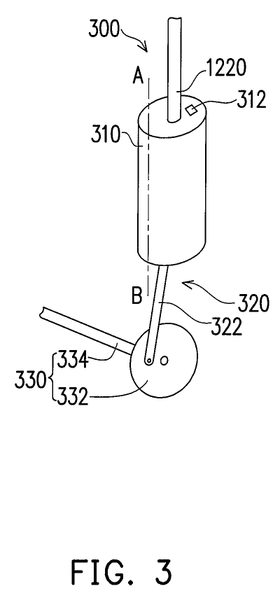

As for the engine 1210, there may be a plurality of embodiments capable of driving the vehicle body 110. FIG. 3 shows one of the embodiments of the engine 1210 employed for driving the vehicle body 110. FIG. 3 shows an external view of the cylinder 300 of the engine 1210 illustrating the components of the cylinder 300. The cylinder 300 generally comprising a cylinder block 310, a piston 320 and a drive shaft 330, are the essential components of the engine 1210 for driving the vehicle body 110.

The cylinder block 310 is hollow inside, and is connected to the gas pipe 1220. An exhaust valve (air release valve) 312, which may be used to discharge the high pressure gas is disposed on the cylinder block 310. The drive shaft 330 comprises a flywheel 332 and a shaft 334 which are tightly fastened to each other. An end of the shaft 334 is connected to the center of flywheel 332, and the long axle of the shaft 334 is roughly vertical to the flywheel. The drive shaft 330 is mainly used to turn the wheels 112 to rotate and to drive the vehicle body 110.

The driving methods employing the drive shaft 330 to drive the vehicle body 110 may be various. The turning shaft 334 of the drive shaft 330 may be connected to the wheels 112, or the drive shaft 330 drives the vehicle body 110 in conjunction with a plurality of gears or belts. However, the method of employing the drive shaft 330 for driving the vehicle body 110 is not used to limit the scope of the present invention.

The piston 320 comprises a connecting rod 322 connected to the drive shaft 330, and the end of the connecting rod 322 is pivoted with the flywheel 332. The end of the connecting rod 332 can be used as an axle to rotate on the flywheel 332.

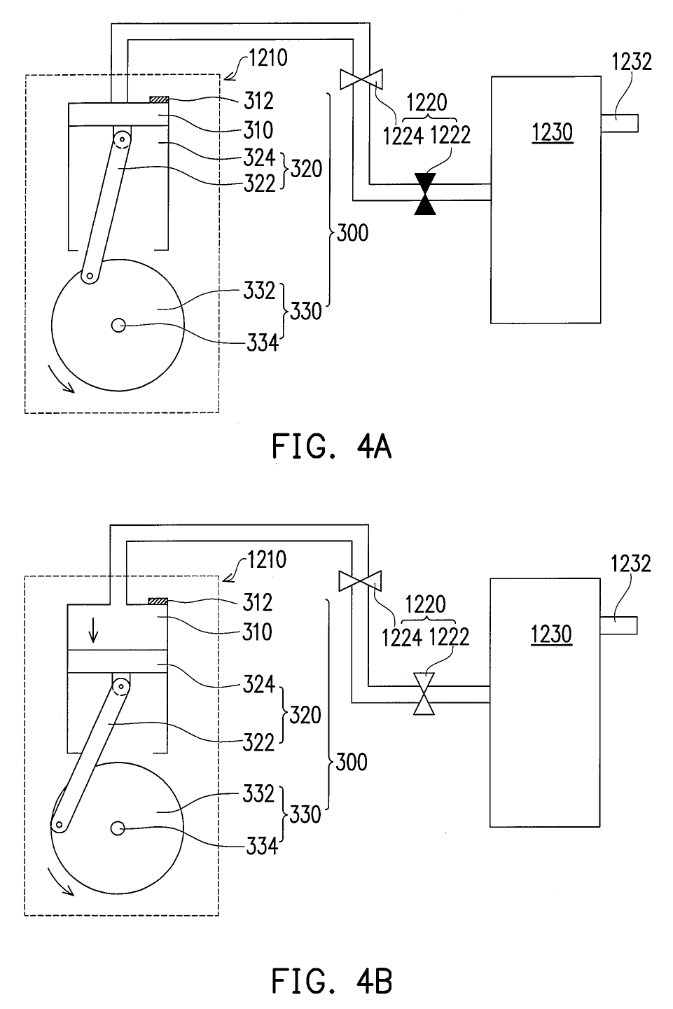

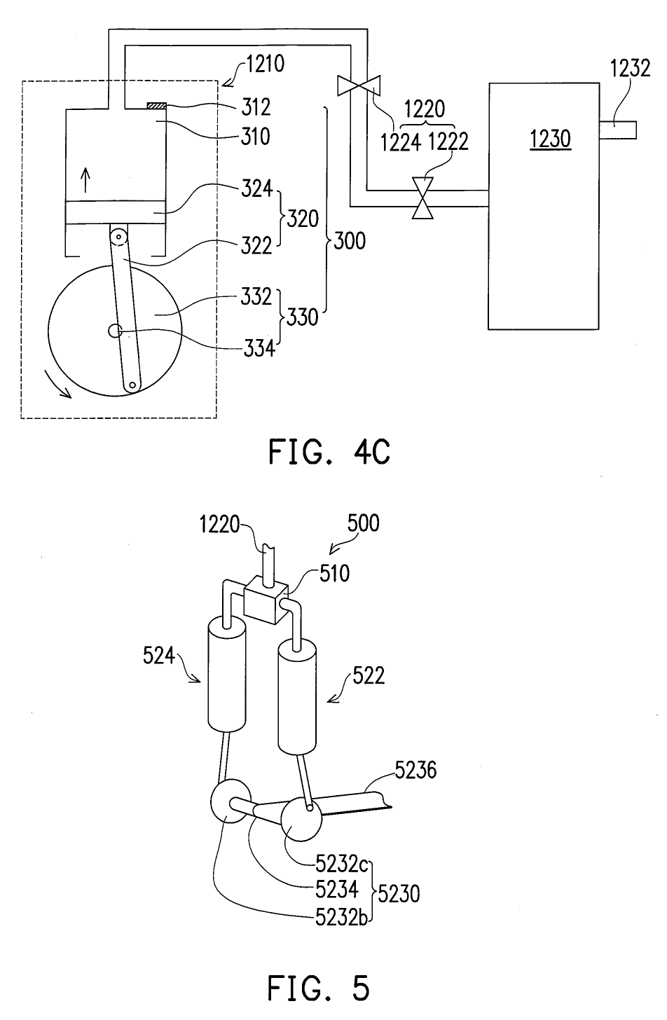

In order to clearly describe how the engine 1210 drives the vehicle body 110, the cylinder block 300's three schematic working diagrams FIG. 4A, FIG. 4B and FIG. 4C will be explained hereinafter.

Referring to FIG. 4A, the cylinder 300 in FIG. 4A is shown from a section view along the section line AB in FIG. 3 to clearly illustrate the internal structure of the cylinder block 310. The whole piston 320 inside the cylinder block 310 can be fully viewed. Besides the connecting rod 322, the piston 320 also comprises a piston head 324 which moves up and down in the cylinder block 310. The connecting rod 322 moves along with the reciprocating action of the piston head 324 to turn the drive shaft 330.

In addition, the gas pipe 1220 as shown in FIG. 4A has a throttle valve 1224 which can control the size of the cross sectional area so as to regulate the flow of high pressure gas. The function of the throttle valve 1224 will be described in detail later.

FIG. 4A schematically illustrates a state when the switch valve 1222 is turned off and there is no high pressure gas in the cylinder 300. In order to illustrate the operation of the cylinder 300, the switch valve 1222 shown in FIG. 4A, FIG. 4B and FIG. 4C illustrate the configuration of on/off state of the switch valve 1222 using black and white color. If the switch valve 1222 is black, it indicates that the switch valve 1222 is in OFF state, if the switch valve 1222 is white, it indicates that the switch valve 1222 is in ON state.

The switch valve 1222 shown in FIG. 4A is black, so it indicates that the switch valve 1222 is in OFF state. At this time, the piston head 324 in the cylinder 300 reaches the upper end of the cylinder block 310, and there is no high pressure gas in the cylinder block 310.

Next, referring to FIG. 4B, the switch valve 1222 shown is white, which indicates that the switch valve 1222 is in ON state. When the switch valve 1222 is in ON state, the high pressure gas in gas tank 1230 enters the cylinder 300 via the gas pipe 1220. At this time, the high pressure gas enters the cylinder block 310 and pushes the piston head 324.

As the piston head 324 being pushed, it drives the connecting rod 322 connected with the piston head 324. While the connecting rod 322 pushes the flywheel 332 to rotate the turning shaft 334. Therefore the drive shaft 330 is turned to drive and move the vehicle body 110.

Next, referring to FIG. 4C, when the piston head 324 is pushed by the high pressure gas from the gas tank 1230, the piston head 324 continuously moves down until the exhaust valve 312 is turned on. At this time, the high pressure gas is released from the exhaust valve 312, and the switch valve 1222 of the gas pipe 1220 is tuned off to stop delivering the high pressure gas to the cylinder block 310. Thus, the piston head 324 can move up and the high pressure gas in the cylinder block 310 is released from the opened exhaust valve 312.

The continuous discharging of the high pressure gas from the cylinder block 310 continuously turns the flywheel 332 to continuously rotate the drive shaft 330. Although the connecting rod 322 can push the flywheel 332, however the rotating flywheel 332 may cause the connecting rod 322 to move up due to moment of inertia. If the flywheel 332 can not move the connecting rod 322 up, the flywheel 332 then can not rotate continuously, and therefore the drive shaft 330 can not rotate continuously so that the vehicle body 110 stops moving. Since the high pressure gas in the cylinder block 310 may prevent the piston head 324 from moving up, therefore the flywheel 332 can not move the connecting rod 322 up, therefore the drive shaft 330 can not continue to rotate. To make the flywheel 332 to move the connecting rod 322 up, the exhaust valve 312 is required to discharge the high pressure gas so that the flywheel 332 can move the connecting rod 322 up, thus the drive shaft 330 can continue to rotate.

When the connecting rod 322 moves up, the piston head 324 moves up accordingly. When the piston head 324 moves up until it reaches the upper end of the cylinder block 310, the cylinder 300 will return to a state shown in FIG. 4A. Next, the cylinder 300 then enters the states shown in FIG. 4B and FIG. 4C, and then returns to the state shown in FIG. 4A. Therefore such cycle can keep piston 320 reciprocating up and down, thus the drive shaft 330 can drive and move the vehicle body 110.

The throttle valve 1224 functions to regulate the flow of the high pressure gas. Since the piston 320 in the cylinder 300 is pushed by the high pressure gas, therefore the greater the force with which the high pressure gas pushes the piston 320 is, the faster the drive shaft 330 rotates, and therefore the faster the vehicle body 110 moves. To increase the force with which the high pressure gas pushes the piston 320, a large amount of the high pressure gas is required to be delivered to push the piston 320. Therefore the throttle valve 1224 can increase the flow of the high pressure gas, so that the force that the high pressure gas pushes the piston 320 is increased, so that the moving speed of the vehicle body 110 is increased. Therefore the throttle valve 1224 is equivalent to the accelerator controlling the speed of the transportation device 100 and 200.

FIG. 5 is another embodiment of the engine according to the present invention. In the engine shown in FIG. 5, the main component is similar to the previous embodiments except for the engine 500 has two cylinders 522 and 524, and a switching valve 510.

The main components of the cylinder 522 and the cylinder 524 are similar to that of the cylinder 300 (as shown in FIG. 3) except for the drive shaft 5230 has a revolving shaft 5234 and two flywheels 5232C and 5232D. Both ends of the revolving shaft 5234 are tightly fastened to the two flywheels 5232C and 5232D at the centers of the flywheels 5232C and 5232D. The long axle of the revolving shaft 5234 is roughly vertical to the two flywheels 5232C and 5232D respectively. In addition, the revolving shaft 5234 has a belt 5236. The drive shaft 5230 drives the belt 5236 to drive the vehicle body 110. Of course, the drive shaft 5230 can also drive a gear or other drive component, therefore the method that drive shaft 5230 drives the vehicle body 110 does not limit the scope of the present invention. Although the appearance of the engine 500 is different with that of the engine 1210, the way of working principle of the cylinders 522 and 524 of the engine 500 is the same as that of the cylinder 300.

The switching valve 510 is connected to the gas pipe 1220. The function of the switching valve 510 is to selectively deliver the high pressure gas to either cylinder 522 or cylinder 524. Since the engine 500 has two cylinders 522 and 524, therefore the flywheels 5232C and 5232D of the drive shaft 5230 can be driven in turn. However, in order to make cylinder 522 or cylinder 524 respectively drives the drive shaft 5230 in turn, the high pressure gas must be restricted not to enter cylinder 522 or cylinder 524 at the same time. Therefore the switching valve 510 is required. In conjunction with the rotation of the drive shaft 5230, the switching valve 510 periodically and alternately delivers the high pressure gas to the cylinder 522 and the cylinder 524, so that the drive shaft 5230 can rotate continuously, thus the vehicle body is driven to move. In addition, the advantage of using the switching valve 510 is that the vehicle body 110 can be driven in a different way with the engine 1210 which has to keep turning the bypass switch valve 1222 between the on and off states constantly to drive the vehicle body 110.

It is known from the above description, the principle of the power system 120 of the present invention is to drive the cylinders 522, 524 or 300 using the pressure of the high pressure gas as the power source to drive the vehicle body 110. Besides compressed noninflammable gas such as high pressure air, high pressure helium or high pressure nitrogen, the high pressure gas may also comprise high pressure helium and nitrogen in liquefied gas (for example liquid nitrogen or liquid helium). That is to say, the gas tank 1230 can store liquid nitrogen or liquid helium. The high pressure gas generated when the liquid nitrogen or the liquid helium is transformed from the liquid phase to the vapor phase is used to increase the air pressure in the gas tank 1230, so as to make the cylinders 522, 524 or 300 operate.

To sum up, the transportation device of the present invention can replace the automobiles that use gasoline as the power source, thus the gasoline shortage problem when the oil in the world is exhausted can be resolved. In addition, the cost on the power source of the transportation device can also be reduced without being affected by the daily increased oil price.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A power system, suitable for use in a transportation device, the power system comprising:
an engine, comprising at least a cylinder having a piston;
a gas tank, for storing a high pressure gas, wherein the high pressure gas is noninflammable; and
a gas pipe, connected to the engine and the gas tank, for delivering the high pressure gas to the cylinder of the engine.

2. The power system according to claim 1, wherein the gas pipe comprises a switch valve, and when the switch valve is turned on, the high pressure gas enters the cylinder and when the switch valve is turned off, entry of the high pressure gas to the cylinder is stopped.

3. The power system according to claim 1, wherein the gas pipe comprises a throttle valve disposed between the engine and the gas pipe.

4. The power system according to claim 2, wherein the engine comprises a plurality of cylinders, and each of the cylinders is connected to the gas pipe, and the gas pipe comprises a switching valve disposed between the cylinders and the switch valve.

5. The power system according to claim 1, wherein the gas tank stores a liquefied gas including liquid nitrogen or liquid helium.

6. The power system according to claim 1, wherein the high pressure gas comprises high pressure air, high pressure helium or high pressure nitrogen.

7. The power system according to claim 1, wherein the gas tank comprises a check valve, and the high pressure gas enters the gas tank via the check valve.

8. The power system according to claim 7, wherein an end of the check valve is connected to an air compressor for filling the high pressure gas from the air compressor to the gas tank for storage.

9. The power system according to claim 7, wherein an end of the check valve is connected to a steel gas cylinder for filling high pressure gas from the steel gas cylinder to the gas tank for storage.

10. A transportation device, comprising:
a vehicle body; and
a power system, disposed inside the vehicle body, comprising:
an engine, comprising at least a cylinder having a piston;
a gas tank, for storing a high pressure gas, the high pressure gas is noninflammable gas; and
a gas pipe, connected to the engine and the gas tank, for delivering the high pressure gas to the cylinder of the engine.

11. The transportation device according to claim 10, wherein the gas pipe comprises a switch valve, and the high pressure gas enters the cylinder when the switch valve is turned on, and the high pressure gas is stopped from entering the cylinder when the switch valve is turned off.

12. The transportation device according to claim 10, wherein the gas pipe comprises a throttle valve disposed between the engine and the gas pipe.

13. The transportation device according to claim 11, wherein the engine comprises a plurality of cylinders connected to the gas pipe, and the gas pipe comprises a switching valve disposed between the cylinders and the switch valve.

14. The transportation device according to claim 10, wherein the gas tank stores a liquefied gas including liquid nitrogen or liquid helium.

15. The transportation device according to claim 10, wherein the high pressure gas comprises high pressure air, high pressure helium or high pressure nitrogen.

16. The transportation device according to claim 10, wherein the gas tank comprises a check valve, and the high pressure gas enters the gas tank via the check valve.

17. The transportation device according to claim 16, further comprising an air compressor connected to the gas tank via the check valve for filling the high pressure gas from the air compressor to the gas tank for storage.

18. The transportation device according to claim 16, wherein an end of the check valve is connected to a steel gas cylinder for filling the high pressure gas from the steel gas cylinder to the gas tank for storage.
